(19) United States
(12) Patent Application Publication
(10) Pub. No.: US 2026/0099882 A1
(43) Pub. Date: Apr. 9, 2026

(54) MANAGING MORTGAGE INSURANCE REFUNDS

(71) Applicant: Wells Fargo Bank, N.A., San Francisco, CA (US)

(72) Inventor: Barry James Nelson, Minneapolis, MN (US)

(21) Appl. No.: 18/907,973

(22) Filed: Oct. 7, 2024

(51) Int. Cl. G06Q 40/08

(52) U.S. Cl. CPC G06Q 40/08

(57) ABSTRACT

Management of mortgage insurance refunds. A navigable dashboard on a display device of a mortgage issuing institution provides customizable navigation of different mortgage insurance refunds that have been disbursed. Underlying the dashboard is a tool that determines discrepancies in refunds and/or calculates discrepancies between disbursement amounts for mortgage insurance refunds and expected disbursement amounts for those mortgage insurance refunds based on mortgage insurance refund polices of different mortgage insurance providers. The discrepancies can be navigated via the dashboard.

### BACKGROUND

Many home mortgages require mortgage insurance. In a typical home lending scenario, a mortgagee obtains a mortgage insurance policy from a third party mortgage insurance provider that is neither the mortgagor nor the mortgagee. Payment of mortgage insurance premiums and refunds of such premiums are then managed by the mortgagee. In most cases, the mortgagor pays monthly premiums as part of their escrow payment, or they can pay a one-time single premium to the mortgagee at the time of closing on the property. The premium is calculated based on various factors. In some situations, a full or partial refund becomes due to the mortgagor at some point after the closing. Mortgage insurance refunds are calculated based on complex mortgage insurance refund policies that can vary significantly based on aspects of the mortgage as well as the entity issuing the mortgage insurance.

### SUMMARY

Examples provided herein are directed to managing mortgage insurance refunds across multiple mortgage insurance refund policies.

According to one aspect, the present disclosure relates to a computer-implemented method of managing mortgage insurance refunds, including: generating, on a display device of a computing device, a first graphical interface, the first graphical interface including a filter for selecting one or more of a plurality of mortgage insurance providers, one or more of the plurality of mortgage insurance providers defining a mortgage insurance refund policy that are different from mortgage insurance refund policies of another of the plurality of mortgage insurance providers; receiving, via the filter, a selection of one of the plurality of mortgage insurance providers; receiving, via the first graphical interface, a value of a discrepancy factor; and based on the selection and the value of the discrepancy factor: retrieving, from a database, data about received mortgage insurance refund corresponding to the one of the plurality of mortgage insurance providers, wherein a disbursement amount of the received mortgage insurance refund has a discrepancy as compared with an expected disbursement amount of the received mortgage insurance refund based on the mortgage insurance refund policy of the one of the plurality of mortgage insurance providers; and generating, on the display device, a second graphical interface, the second graphical interface being populated with the data.

According to another aspect, the present disclosure relates to a system for managing mortgage insurance refunds, including: a database storing scripts, each of the scripts corresponding to a different one of a plurality of mortgage insurance refund policies; at least one processor; and non-transitory computer-readable storage storing instructions that, when executed by the at least one processor, causes the at least one processor to: receive data about received mortgage insurance refund, the data including a disbursement amount of the received mortgage insurance refund; match, based on the data, the received mortgage insurance refund to only one of the scripts; execute the one of the scripts using the data to calculate an expected disbursement amount of the received mortgage insurance refund; compare the disbursement amount and the expected disbursement amount to calculate a discrepancy between the disbursement amount that the expected disbursement amount; and store the discrepancy and the data in the database.

According to another aspect, the present disclosure relates to a system for managing mortgage insurance refunds, including: a display device; a database storing scripts, each of the scripts corresponding to a different one of a plurality of mortgage insurance refund policies; at least one processor; and non-transitory computer-readable storage storing instructions that, when executed by the at least one processor, causes the at least one processor to: receive data about received mortgage insurances refunds, the data including disbursement amounts of the received mortgage insurance refunds; match, based on the data, each of the received mortgage insurance refunds to a different one of the scripts, the scripts being generated based on refund schedule data stored in mortgage insurance refund schedules and refund factors including loan to value ratios of mortgages for home purchases factors, loan terms factors, lengths of time the mortgages have been in force factors, locations of homes corresponding to the home purchases factors; execute the scripts using the data to calculate expected disbursement amounts of the received mortgage insurance refunds; compare the disbursement amounts and the expected disbursement amounts to calculate discrepancies between the disbursement amounts and corresponding ones of the expected disbursement amounts; store the discrepancies and the data in the database; and generate on the display device a mortgage insurance refund management dashboard, the mortgage insurance refund management dashboard being configured to display information about one or more of the discrepancies based on filter inputs provided to the mortgage insurance refund management dashboard.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for managing mortgage insurance refund discrepancies.

FIG. 2 shows an example method that can be performed using the system of FIG. 1.

FIG. 3 shows an example display device displaying a graphical interface that can be generated using the system of FIG. 1.

FIG. 4 shows the display device displaying further aspects of the graphical interface of FIG. 3.

FIG. 5 shows example physical components of one or more devices of the system of FIG. 1.

### DETAILED DESCRIPTION

This disclosure relates to managing discrepancies in mortgage insurance refunds. In examples, the disclosure relates particularly to managing discrepancies in mortgage insurance refunds for mortgage insurance policies provided by private mortgage insurance companies.

Mortgage insurance is an insurance policy that protects a lender or titleholder if the borrower (e.g., a mortgagor) defaults on payments or is otherwise unable to meet the obligations of the mortgage. Many mortgagees require mortgagors to pay for mortgage insurance if the down payment on a home purchase is less than a threshold amount (e.g., 20%). The mortgagee may arrange for the mortgage insurance with a private mortgage insurance company (e.g., a mortgage insurance provider). Payments for the mortgage insurance may be made by the mortgagor through monthly payments to escrow, as a single lump sum payment at closing, or by some combination of a payment at closing and regular payment installments thereafter.

Various rules dictate when a given mortgage insurance policy can terminate automatically. For example, in some circumstances a mortgage insurance policy can terminate when the loan to value ratio (LTV) on the mortgage is reduced to a threshold percentage (e.g., 78 percent). As examples, in some circumstances a mortgage insurance policy can terminate when the loan is paid in full, or when the mortgagor requests cancellation. In these situations, the borrower may be entitled to a refund or partial refund of funds paid toward the mortgage insurance policy.

Determining the appropriate amount for a refund is a complicated process that is further complicated by the indirect relationship that the mortgagor has with the mortgage insurance provider. Typically, and unlike, for example, other types of insurance such as hazard insurance, the mortgagor has no say in which mortgage insurance provider to use and has no direct interactions with the mortgage insurance provider. Rather, all interactions with the mortgage insurance provider are between the mortgagee and the mortgage insurance provider.

Most mortgagees (e.g., financial institutions) work with multiple private mortgage insurance companies for providing mortgage insurance to mortgagors. Each mortgage insurance provider has its own set of processes and rules for determining when a refund is permitted and what the amount of the refund should be. These processes and rules are typically embodied in complex mortgage insurance refund policies that can be unique to each mortgage insurance provider. The various different policies can consider various different refund factors that can be weighted to various different degrees. Non-limiting examples of such factors can include initial LTV, current LTV, the term of the mortgage loan, the length of time the mortgage has been in force, the location of the mortgaged property (e.g., the state), and the like.

Using one or more of these and/or other refund factors, in some cases one or more schedules of refunds can be consulted to determine the appropriate refund in a particular scenario. The schedules can differ from mortgage insurance provider to mortgage insurance provider, as well as based on different refund factors, such as the state in which the purchased home is located. For instance, while selection from one set of refund schedules for a given mortgage insurance provider may be appropriate for consulting for a home purchased in Minnesota, selection from an entirely different set of possible refund schedules by the same mortgage insurance provider may be appropriate for consulting for a home purchased in New York.

Typically, a loan servicer (e.g., a typical mortgagee) simply relies on each mortgage insurance provider to accurately calculate and issue refunds that the loan servicer then passes on to the mortgagor. However, because a given mortgagee (e.g., a financial institution) may manage mortgage insurance policies across many different mortgages for many different mortgagors to which many different mortgage refund policies apply, errors in mortgage insurance refund amounts can arise that are missed by the mortgagee. Such errors can include disbursing too high or too low of a refund, disbursing a refund when a refund is not due, or failing to disburse a refund when a refund is due.

As such, management of multiple mortgage insurance policies and their refunds across multiple mortgages presents a technological problem to financial institutions that issue mortgages. The present disclosure provides technological solution to this technical problem, such as a centralized digital platform (including a dashboard) that is specifically configured for overseeing and managing a multitude of disparate third party mortgage insurance policies and third party mortgage insurance refund policies all in one, convenient place. The centralized platform is kept updated as each new mortgage refund is received by the mortgagee The centralized and automated nature of the platform minimizes mortgage insurance refund discrepancies and dramatically reduces the time it takes to process and disburse a received refund to the mortgagor. Existing technologies do not provide such platforms or dashboards.

According to certain examples of managing mortgage insurance refunds in accordance with the present disclosure, a navigable, dynamic dashboard on a display device of a mortgage issuing institution is generated and provides customizable navigation of different mortgage insurance refunds owed to or already disbursed to mortgagors. The dashboard is narrowly tailored to overseeing and managing disbursed mortgage insurance refunds and ensuring that the disbursed refunds have been calculated correctly based on the corresponding refund policies.

According to certain examples, underlying the dashboard is a dynamic, trigger-responsive tool that encodes multiple mortgage insurance refund policies that the tool uses to calculate discrepancies between disbursement amounts for mortgage insurance refunds and expected disbursement amounts for those mortgage insurance refunds based. The discrepancies can be navigated via the dashboard.

These and other technological solutions to technological problems will be borne out by the present disclosure.

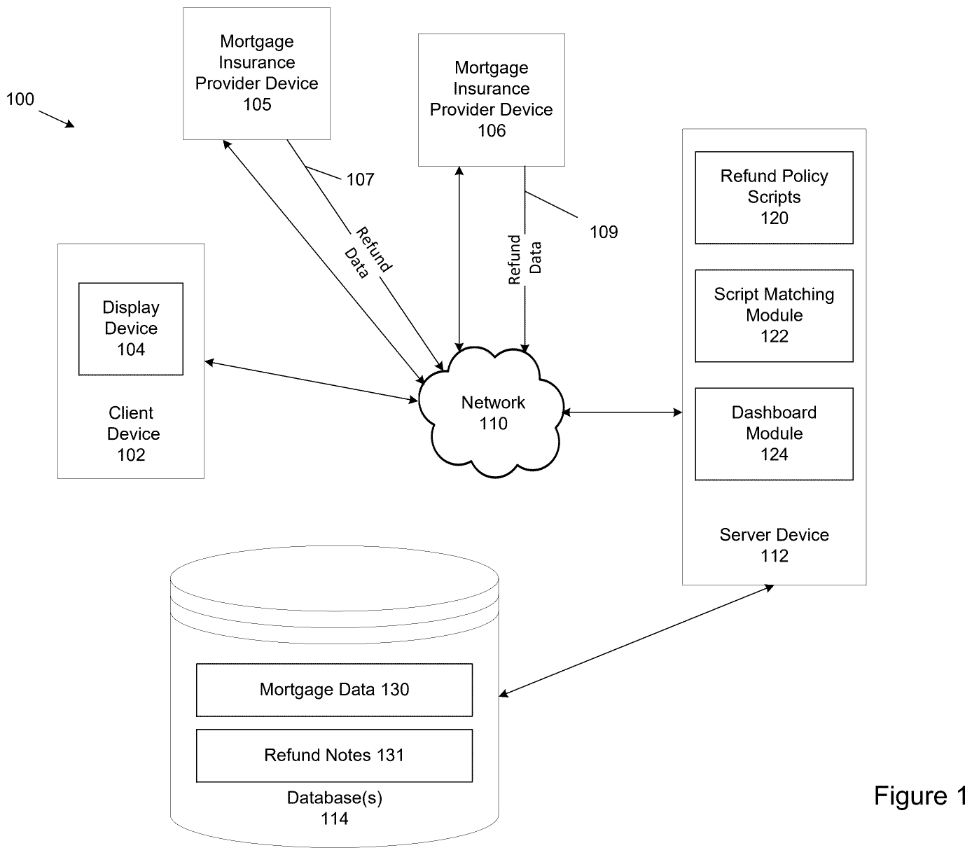

FIG. 1 shows an example system 100 for managing mortgage insurance refund discrepancies.

In this instance, the system 100 includes a client device 102, multiple mortgage insurance provider devices, such as the mortgage insurance provider device 105 and the mortgage insurance provider device 106, a server device 112, and one or more databases 114.

Each of the client device 102, and the mortgage insurance provider devices 105 and 106 can communicate with the server device 112 through a network 110 to perform the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

In some non-limiting examples, the server device 112 is owned by a financial institution, such as a bank, that serves as mortgagee on many mortgages (e.g., more than 100 or more than 1,000 mortgages).

In some non-limiting examples, the client device 102 is owned by the financial institution as well. For example, the client device 102 can be a terminal or work station that can be operated by a stakeholder of the financial institution and can interact with the server device 112 to perform functionalities described herein.

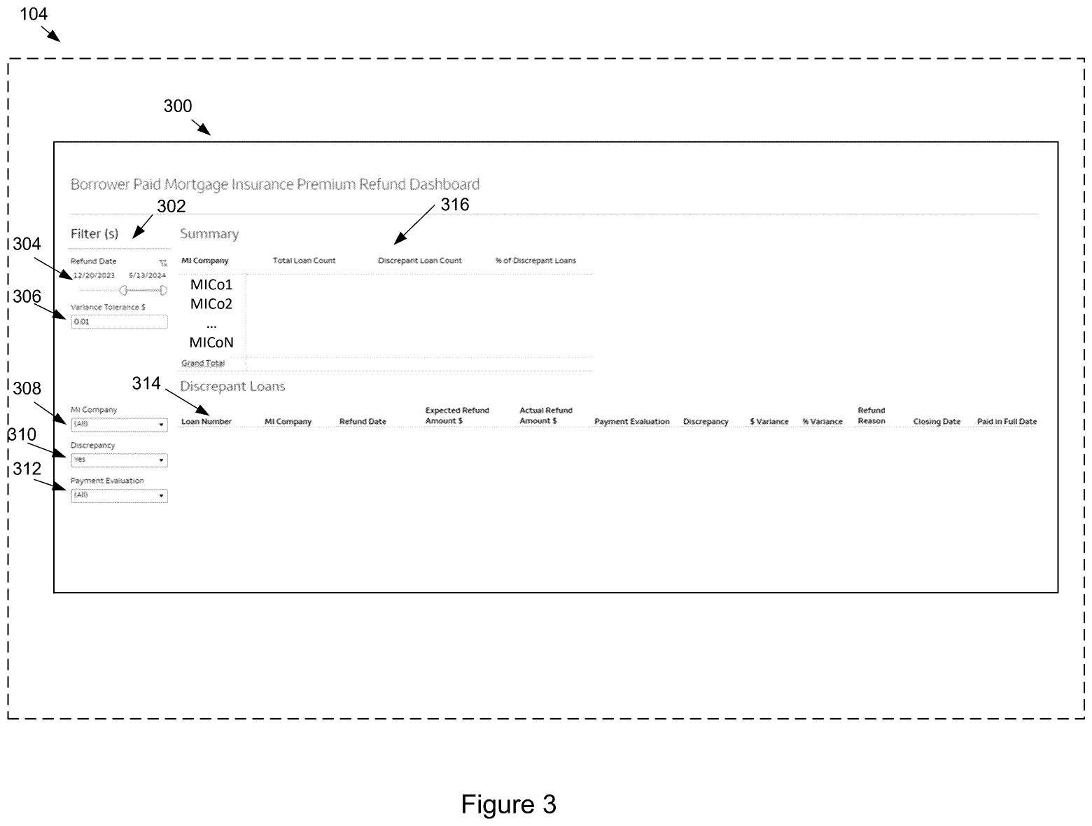

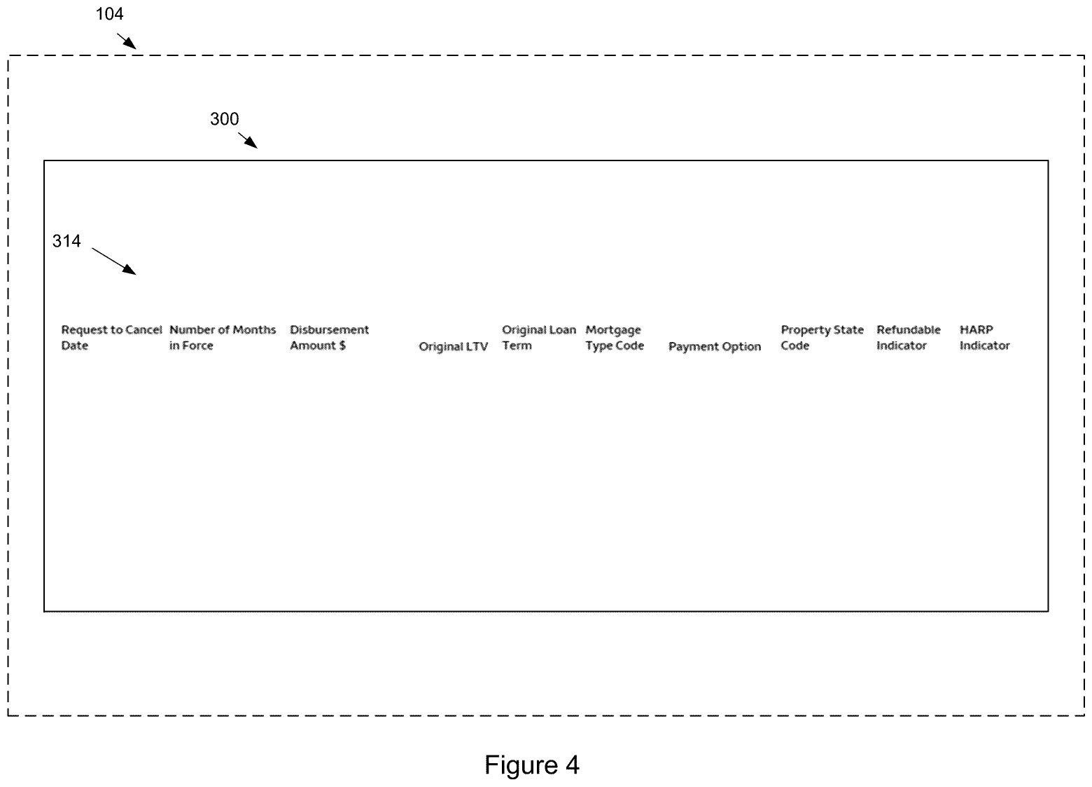

For instance, the client device 102 can include a display device 104. The server device 112 can be configured to generate interactive graphical interfaces on the display device 104, such as the graphical interface 300 of FIGS. 3 and 4.

Each of the mortgage insurance provider devices 105, 106 can be owned and/or operated by a different mortgage insurance provider that has a relationship with the financial institution. In addition, each mortgage insurance provider that has a relationship with the financial institution can have its own set of one or more mortgage insurance refund policies, each based on its own sets of factors, weights, schedules and the like.

While in the example system 100 only two such mortgage insurance provider devices 105, 106 are shown, corresponding to two different mortgage insurance providers, in some examples many such devices (e.g., 10 or more such devices, 20 or more such devices, 50 or more devices, 100 or more devices) and a corresponding number of mortgage insurance providers can be in communication with the server device 112.

The example database 114 of the system 100 is programmed to store mortgage data 130. The mortgage data 130 relates to the active mortgages managed by the financial institution. The server device 112 accesses the mortgage data from the database(s) 114 to generate a centralized mortgage insurance refund dashboard. In some examples, the database 114 is a relational database, an object-oriented database, a hierarchical database, and/or a cloud database that stores various components of the mortgage data 130. Many other configurations are possible.

The mortgage data 130 can include, for one or more mortgages, data relating to one or more of an Identification (ID) number for the mortgage loan, the name of the mortgage insurance provider for the mortgage, a date of closing on the home corresponding to the mortgage, a date on which the mortgage insurance was paid in full, a date on which a request to cancel the mortgage insurance policy was received, a number of months a mortgage insurance policy has been in force, the original LTV for the mortgage loan, an indicator of the legal type of the mortgage, the original term for the mortgage loan, an indicator for the mortgage based on provisions of the Home Affordable Refinance Program (HARP), and the location (e.g., state) in which the home corresponding to the mortgage is located. Other types of mortgage data 130 are possible.

The network 110 provides a wired and/or wireless connection between the client device 102, the server device 112, and the mortgage insurance provider devices 105 and 106. In some examples, the network 110 can be a local area network, a wide area network, the Internet, a near field communication (NFC) network, or a mixture thereof. Many different communication protocols can be used. Although only four devices are shown, the system 100 can accommodate hundreds, thousands, or more of computing devices.

The server device 112 includes software modules for performing functionalities of the system 100 described herein.

For example, the server device 112 can include refund policy scripts 120, a script matching module 122, and a dashboard module 124.

In an example use case, the system 100 can operate as follows.

The server device 112 generates refund policy scripts 120. Each refund policy script encodes a mortgage insurance refund policy of a mortgage insurance provider with which the financial institution has a relationship. For example, each script can correspond to one of the mortgage insurance refund policies of one of the mortgage insurance providers corresponding to one of the mortgage insurance provider devices 105, 106.

Each script of the refund policy scripts 120 can be generated, e.g., from one or more documents that describe corresponding refund policy. Such documents can include refund calculation rules that define the factors and weights that go into calculating mortgage insurance refunds in different situations. Such documents can also include one or more schedules containing refund calculation data for different scenarios. Such documents can be retrieved from one or more webpages, and/or directly from the mortgage insurance provider devices 105, 106.

Each script of the refund policy scripts 120 can include a script ID that, e.g., identifies the mortgage insurance refund policy and/or mortgage insurance provider to which it corresponds. The refund policy scripts 120 can be stored in a database, such as the database(s) 114, and selectively accessed by the server device 112 for execution in response to a mortgage insurance refund triggering event (e.g., updating of refund notes 131 based on receipt of refund data 107, 109), as further described herein.

Following cancellation of a mortgage insurance policy, the corresponding mortgage insurance provider determines whether to issue a refund. When the mortgage insurance provider determines to issue and does issue a mortgage insurance refund for the cancelled policy (e.g., based on one more insurance refund conditions having been met for a given mortgage) or determines not to issue a refund for the cancelled policy, data associated with the refund or non-refund are generated. For example, each mortgage insurance provider device 105, 106 can generate and transmit refund data 107, 109 corresponding to a refund or decision not to refund for a corresponding mortgage insurance policy.

The refund data can include, for example, an ID of a corresponding mortgage or mortgage loan, an indication that a refund has been issued or is not being issued, an amount of an issued refund, an ID for the corresponding mortgage insurance provider, the date a refund was issued, and a reason for issuing or not issuing a refund.

The refund data 107, 109 is transmitted to the server device 112. The refund data is then stored as mortgage insurance refund notes 131 in a database, such as the database 114. The refund notes serve as the trigger for the server device 112 to determine that a refund was obtained.

The script matching module 122 matches the refund notes 131 to the corresponding refund policy script 120. That is, based on the refund data 107, 109 as stored in the refund notes 131, the script matching module 122 identifies the script 120 corresponding to the refund policy that governs the mortgage associated with the refund data 107, 109.

Once the match has been made, the server device 112 causes the matched script 120 to be automatically executed. That is, receipt of the refund notes 131 by the server device 112 triggers one of the scripts 120 to be executed.

The script 120 being executed pulls in data associated with the factors needed to determine if the mortgage insurance refund was in fact warranted and, if so, calculates the expected amount the refund should have been. Such factors can be pulled, e.g., from the refund notes 131 and the mortgage data 130. The expected amount of the refund can be stored in the database(s) 114, e.g., merged with the corresponding mortgage data 130 associated with the same mortgage.

The server 112 is also configured to compare the calculated expected refund amount to the issued refund amount, thereby determining if there is a discrepancy between the expected and issued refund amounts and, if so, the magnitude of such discrepancy and whether the discrepancy is positive or negative. The calculated data about the discrepancy can then be stored in the database(s) 114, e.g., merged with the corresponding mortgage data 130 associated with the same mortgage.

The dashboard module 124 is configured to generate signals that are transmitted to the client device 102 and generate a dashboard on the display device 104, the dashboard representing a centralized platform for overseeing and managing mortgage insurance refunds via the display device 104. The dashboard can be a series of interactive graphical interfaces that can receive input via the client device 102 and provide output in response to input. Processing of such input and generating of signals that cause generation of such output are performed by the dashboard module 124. For example, the dashboard module 124 can be configured to cause the client device 102 to generate the graphical interface 300 of FIGS. 3 and 4 on the display device 104.

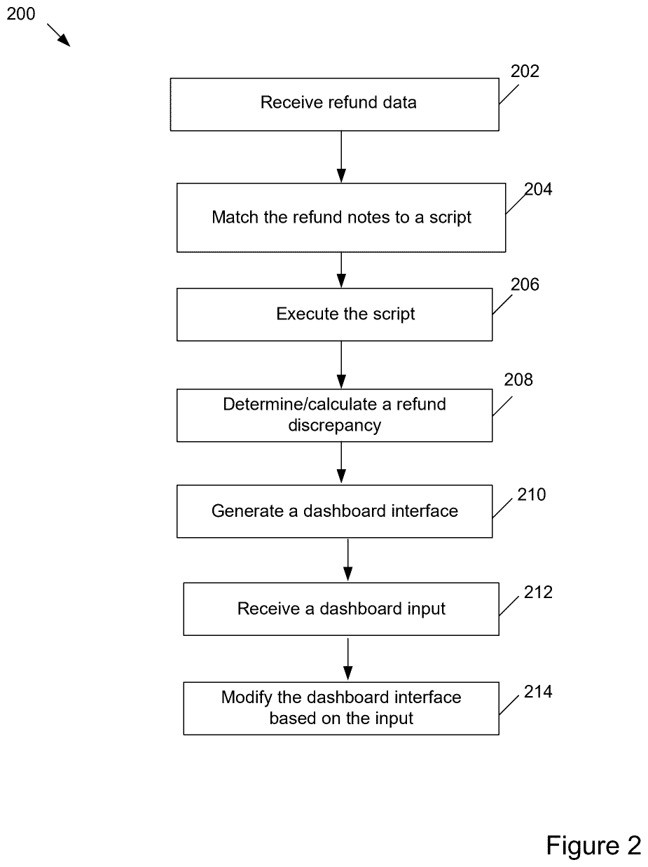

FIG. 2 shows an example method 200 that can be performed using the system 100 of FIG. 1. Methods of the present disclosure can include more or fewer steps than the enumerated steps of method 200. Methods of the present disclosure can include steps of the method 200 performed in a different order than depicted. In some examples, at least some of the steps of the method 200 are performed by the server device 112. In some examples, some of the steps of the method 200 are performed by one or more other devices of the system 100.

Referring to FIG. 2, at the step 202 of the method 200, a mortgage insurance refund data is received.

At a step 204 of the method 200 (which can be triggered by updating the refund notes 131 (FIG. 1) based on the refund data received at the step 202) ), the updated refund notes are matched to a script corresponding to a mortgage insurance refund policy.

At a step 206 of the method 200, the matched script is executed.

At a step 208 of the method 200, as a result of executing the script a discrepancy in the issued refund versus an expected refund is determined. In some examples, a magnitude or variance of the discrepancy is also calculated.

At a step 210 of the method 200, a centralized mortgage insurance refund management dashboard interface is generated.

At a step 212 of the method 200, an input is received via the dashboard.

At a step 214 of the method 200, the dashboard interface is modified based on the input.

FIG. 3 shows an example display device 104 of the system 100 of FIG. 1 displaying a graphical interface 300 that can be generated using the system of FIG. 1.

FIG. 4 shows the display device 104 of FIG. 3 displaying further aspects of the graphical interface 300 of FIG. 3.

Referring to FIGS. 3 and 4, the graphical interface 300 is a centralized mortgage insurance refund management dashboard generated by the system of FIG. 1.

The graphical interface 300 includes filters 302. The filters 302 allow the mortgage insurance refund discrepancy information provided via the dashboard to be adjusted and customized. The filters 302 include one or more slide bars, drop down menus, and/or data entry fields. Each of the filters 302 represents a refund discrepancy factor that can be set via the filter to adjust or customize the information provided via the dashboard.

In this example, the filters 302 include a refund date filter 304. The refund date filter 304 includes a pair of slide bars that can be adjusted to select an exclusive range of refund issuance dates from which to capture any refund issuances or refund decisions that have (and/or do not have) discrepancies for display on the dashboard.

The filters 302 include a variance tolerance filter 306. The variance tolerance filter 306 includes a data field entry for entering a threshold dollar amount (e.g., one cent) of a discrepancy between an issued refund amount and an expected refund amount in order for the dashboard to capture and display that refund as a discrepant refund.

The filters 302 include a mortgage insurance provider filter 308. The mortgage insurance provider filter 308 includes a drop down menu from which one or more mortgage insurance providers can be selected such that the dashboard captures and displays only discrepant refunds issued by the selected mortgage insurance provider(s). For example, the selected mortgage insurance providers can include MICo1, MICo2 up to and including MICoN, wherein N is a positive integer greater than 2.

The filters 302 include a discrepancy filter 310. The discrepancy filter is a drop down menu that allows selection of only issued refunds that are discrepant, only issued refunds that are not discrepant, or all issued refunds whether or not discrepant to be captured and displayed on the dashboard.

The filters 302 include a payment evaluation filter 312. The payment evaluation filter is a drop down menu that allows selection of only discrepancies in which the issued refund amount exceeds the expected refund amount, only discrepancies in which the expected refund amount exceeds the issued refund amount, or both types of discrepancies to be captured and displayed on the dashboard.

Based on the inputs and selections in the filters 302, the graphical interface 300 populates a table 314 with different types of data about each issued refund that meets the filter criteria. The data that populate the table 314 can be obtained from the mortgage data 130, the refund notes 131,, and outputs from executed refund policy scripts 120 (FIG. 1).

For each such issued refund, the table 314 can provide, for example, one or more of a mortgage loan number, the name of the mortgage insurance provider, the date of any refund that has been paid, the calculated expected refund amount, the mortgage insurance providers' issued refund amount, whether the expected refund amount exceeds the issued refund amount or vice versa, an indicator as to whether or not there is a discrepancy between the issued and expected refund amounts, a dollar amount magnitude of any discrepancy, a percentage amount magnitude of any discrepancy, a reason the refund was issued, a date on which the home associated with the insured mortgage closed, a date on which the mortgage insurance premiums were fully paid, a date on which the mortgage insurance policy was requested to be canceled, a length of time the mortgage insurance policy was in force, an amount, if any, of any disbursement to the mortgagor to date due to the issued refund, the original LTV (e.g., at the time of closing) for the mortgage loan, an indicator of the type of mortgage, a payment option for any refund that is due, an indicator of the location (e.g., the state) of the purchased home, an indicator as to whether the mortgage insurance policy in question is refundable, and an indicator that categorizes the mortgage based on HARP.

The graphical interface also includes a summary chart 316 that summaries centralized mortgage insurance refund data for each mortgage insurance provider selected via the mortgage insurance provider filter 308. For example, for each selected mortgage insurance provider, the summary chart 316 provides the total number of mortgage loans serviced by the mortgage insurance provider in which a mortgage insurance refund has been issued, the total number of those mortgage loans that have associated therewith a discrepant issued refund, and a percent of those mortgage loans that have a discrepant issued refund.

The graphical interface 300 thus provides an easily navigable dashboard that centralizes in one place data related to mortgage insurance refunds across many mortgages, mortgagors and mortgage insurance providers.

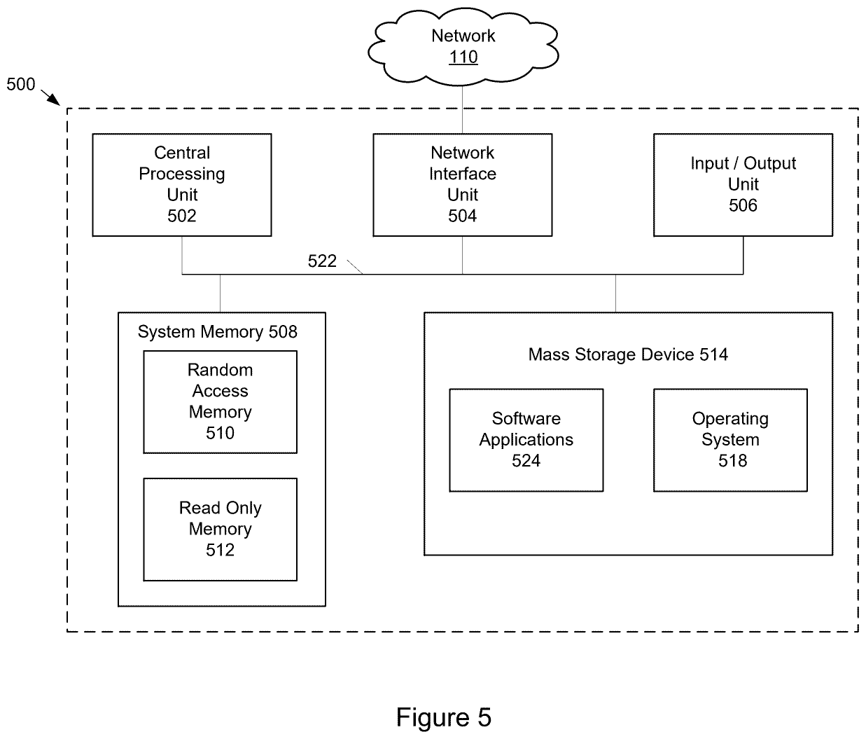

Additional components of the system 100 of FIG. 1 are illustrated in FIG. 5.

The electronic computing device 500 can correspond to any of the server device 112, the client device 102, or the mortgage insurance provider device 106 of FIG. 1. Components of the computing device 400 can correspond to other components of the system 100 of FIG. 1, such as the database(s) 114.

When the computing device 500 corresponds to the server device 112, the computing device 500 can be an internally controlled and managed device (or multiple devices) of an enterprise, e.g., a financial institution that offers various banking services to its customers, including mortgages of home purchases. Alternatively, the computing device 500 can represent one or more devices operating in a shared computing system external to the enterprise, such as a cloud.

As illustrated in the embodiment of FIG. 5, the example computing device 500, which provides the functionality described herein, can include at least one central processing unit (“CPU”) 502, a system memory 508, and a system bus 522 that couples the system memory 508 to the CPU 502. The system memory 508 includes a random access memory (“RAM”) 510 and a read-only memory (“ROM”) 512. A basic input/output system containing the basic routines that help transfer information between elements within the computing device 500, such as during startup, is stored in the ROM 512. The computing device 500 further includes a mass storage device 514. The mass storage device 514 can store software instructions and data. A central processing unit, system memory, and mass storage device similar to that shown can also be included in the other computing devices disclosed herein.

The mass storage device 514 is connected to the CPU 502 through a mass storage controller (not shown) connected to the system bus 522. The mass storage device 514 and its associated computer-readable data storage media provide non-volatile, non-transitory storage for the computing device 500. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 500.

According to various embodiments of the invention, the computing device 500 may operate in a networked environment using logical connections to remote network devices through network 110, such as a wireless network, the Internet, or another type of network, or combination of networks. The computing device 500 may connect to a network 110 through a network interface unit 504 connected to the system bus 522. The computing device 500 also includes an input/output unit 506 for receiving and processing input from a number of other devices, including a touch user interface display screen or another type of input device.

Similarly, the input/output unit 506 may provide output to a touch user interface display screen or other output devices. In examples where the client device 102 of FIG. 1 corresponds to the computing device 500, the input/output unit 506 can include the display device 104.

As mentioned briefly above, the mass storage device 514 and the RAM 510 of the computing device 500 can store software instructions and data. The software instructions include an operating system 518 suitable for controlling the operation of the computing devices of the system 100. The mass storage device 514 and/or the RAM 510 also store software instructions and applications 524, that when executed by the CPU 502, cause the computing device 500 to provide the functionality of the various devices of the system 100 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer-implemented method of managing mortgage insurance refunds, comprising:
generating, on a display device of a computing device, a first graphical interface, the first graphical interface including a filter for selecting one or more of a plurality of mortgage insurance providers, one or more of the plurality of mortgage insurance providers defining a mortgage insurance refund policy that are different from mortgage insurance refund policies of another of the plurality of mortgage insurance providers;
receiving, via the filter, a selection of one of the plurality of mortgage insurance providers;
receiving, via the first graphical interface, a value of a discrepancy factor; and
based on the selection and the value of the discrepancy factor:
retrieving, from a database, data about a received mortgage insurance refund corresponding to the one of the plurality of mortgage insurance providers, wherein a disbursement amount of the received mortgage insurance refund has a discrepancy as compared with an expected disbursement amount of the received mortgage insurance refund based on the mortgage insurance refund policy of the one of the plurality of mortgage insurance providers; and
generating, on the display device, a second graphical interface, the second graphical interface being populated with the data.

2. The computer-implemented method of claim 1, wherein the data include a magnitude of the discrepancy.

3. The computer-implemented method of claim 1, wherein the data include a reason for the received mortgage insurance refund.

4. The computer-implemented method of claim 1, wherein the data include an expected amount of the received mortgage insurance refund.

5. The computer-implemented method of claim 1, wherein the data include a date that the mortgage insurance refund was received, a name of the one of the plurality of mortgage insurance providers, and a number of a mortgage loan corresponding to the received mortgage insurance refund.

6. The computer-implemented method of claim 1, wherein the data include a date of a closing of a home purchase corresponding to the received mortgage insurance refund.

7. The computer-implemented method of claim 1, wherein the data include a loan to value ratio of a mortgage for a home purchase corresponding to the received mortgage insurance refund.

8. The computer-implemented method of claim 7, wherein the data include a term of a mortgage loan corresponding to the received mortgage insurance refund.

9. The computer-implemented method of claim 1, further comprising:
generating an algorithm based on the mortgage insurance refund policy of the one of the plurality of mortgage insurance providers;
capturing a portion of the data from refund data, the capturing being triggered by receipt of the refund;
providing the portion of the data to the algorithm;
using the algorithm, and based on the portion of the data:
detecting the discrepancy; and
calculating a value of the discrepancy.

10. The computer-implemented method of claim 1, wherein the discrepancy factor is whether the discrepancy is above an expected amount of the received mortgage insurance refund or below the expected amount of the received mortgage insurance refund.

11. The computer-implemented method of claim 1, wherein the discrepancy factor defines a minimum magnitude of the discrepancy.

12. A system for managing mortgage insurance refunds, comprising:
a database storing scripts, each of the scripts corresponding to a different one of a plurality of mortgage insurance refund policies;
at least one processor; and
non-transitory computer-readable storage storing instructions that, when executed by the at least one processor, causes the at least one processor to:
receive data about a received mortgage insurance refund, the data including a disbursement amount of the received mortgage insurance refund;
match, based on the data, the received mortgage insurance refund to only one of the scripts;
execute the one of the scripts using the data to calculate an expected disbursement amount of the received mortgage insurance refund;
compare the disbursement amount and the expected disbursement amount to calculate a discrepancy between the disbursement amount that the expected disbursement amount; and
store the discrepancy and the data in the database.

13. The system of claim 12, wherein the instructions, when executed by the at least one processor, cause the at least one processor to generate a graphical interface on a display device, the graphical interface including the data and the discrepancy.

14. The system of claim 12, wherein the data are obtained from refund data.

15. The system of claim 14, wherein receipt of the refund data causes refund notes stored on the database to be updated.

16. The system of claim 12, wherein the one of the scripts is generated based on refund factors including a loan to value ratio of a mortgage for a home purchase factor, a loan term factor, and a length of time the mortgage has been in force factor.

17. The system of claim 16, wherein the refund factors include a location of a home corresponding to the home purchase factor.

18. The system of claim 17, wherein the one of the scripts is generated based on refund schedule data stored in a mortgage insurance refund schedule.

19. A system for managing mortgage insurance refunds, comprising:
a display device;
a database storing scripts, each of the scripts corresponding to a different one of a plurality of mortgage insurance refund policies;
at least one processor; and
non-transitory computer-readable storage storing instructions that, when executed by the at least one processor, causes the at least one processor to:
receive data about received mortgage insurances refunds, the data including disbursement amounts of the received mortgage insurance refunds;
match, based on the data, each of the received mortgage insurance refunds to a different one of the scripts, the scripts being generated based on refund schedule data stored in mortgage insurance refund schedules and refund factors including loan to value ratios of mortgages for home purchases factors, loan terms factors, lengths of time the mortgages have been in force factors, locations of homes corresponding to the home purchases factors;
execute the scripts using the data to calculate expected disbursement amounts of the received mortgage insurance refunds;
compare the disbursement amounts and the expected disbursement amounts to calculate discrepancies between the disbursement amounts and corresponding ones of the expected disbursement amounts;
store the discrepancies and the data in the database; and
generate on the display device a mortgage insurance refund management dashboard, the mortgage insurance refund management dashboard being configured to display information about one or more of the discrepancies based on filter inputs provided to the mortgage insurance refund management dashboard.

20. The system of claim 19, wherein the mortgage insurance refund management dashboard includes filters for receiving the filter inputs, the filters including a date of refund filter, a discrepancy magnitude filter, a mortgage insurance provider filter, a discrepancy toggle filter, and a discrepancy type filter.
